(19) United States
(12) Patent Application Publication
(10) Pub. No.: US 2005/0037757 A1
(43) Pub. Date: Feb. 17, 2005

(54) Mobile communication system for handoff between heterogeneous mobile communication networks and handoff method using the same

(75) Inventors: Yong-Woon Moon, Seoul (KR); Kyung-Chik Kim, Suwon-si (KR)

Correspondence Address: DILWORTH & BARRESE, LLP, 333 EARLE OVINGTON BLVD., UNIONDALE, NY, 11553, US

(73) Assignee: SAMSUNG ELECTRONICS CO., LTD., GYEONGGI-DO (KR)

(21) Appl. No.: 10/812,288

(22) Filed: Mar. 29, 2004

(30) Foreign Application Priority Data
Aug. 12, 2003 (KR) 55890/2003
Sep. 9, 2003 (KR) 63140/2003

(51) Int. Cl. H04M 1/00

(52) U.S. Cl. 455/436

(57) ABSTRACT

Disclosed is a mobile communication system for handover between heterogeneous mobile communication networks. A dual-mode terminal has first and second modules capable of performing communication in first and second heterogeneous communication technologies, respectively. The dual-mode terminal measures strength of a signal received by the first module to determine whether the dual-mode terminal has moved between the mobile communication networks. If it is determined that the dual-mode terminal moves to a different network, the dual-mode terminal measures the strength of a signal transmitted from the different network, and converts measurement information into a first SMS message. A first mobile communication network device provides a service for performing communication with the first module, restores data from the first SMS message, and transmits the restored data to an interface network. The first mobile communication network device converts channel assignment information transmitted from the interface network into an SMS message, and transmits the SMS message to the dual-mode terminal. A second mobile communication network device communicates with the second module, detects the measurement information from the data transmitted from the first mobile communication network device to assign a channel for communicating with the second module, and transmits channel assignment information to the first mobile communication network device.

### PRIORITY

This application claims priority under 35 U.S.C. § 119 to an application entitled “Mobile Communication System for Handoff Between Heterogeneous Mobile Communication Networks and Handover Method Using the Same” filed in the Korean Intellectual Property Office on Aug. 12, 2003 and assigned Serial No. 2003-55890, and an application entitled “Mobile Communication System for Handover Between Heterogeneous Mobile Communication Networks and Handover Method Using the Same” filed in the Korean Intellectual Property Office on Sep. 9, 2003 and assigned Serial No. 2003-63140, the contents of both of which are incorporated herein by reference.

### BACKGROUND OF THE INVENTION

1. Field of the Invention

The present invention relates generally to a handover method between heterogeneous mobile communication networks, and in particular, to a mobile communication system for performing a handover when a portable terminal moves between an asynchronous mobile communication network and a synchronous mobile communication network, and a handover method using the same.

2. Description of the Related Art

Next generation mobile communication technologies aiming at securing global compatibility have been separately standardized into UMTS (Universal Mobile Telecommunications System) led by Europe and Japan and CDMA (Code Division Multiple Access) One led by the United States and South Korea. UMTS is typical asynchronous mobile communication technology, while CDMA is typical synchronous mobile communication technology. In South Korea, 2.5^{th} Generation (2.5G) CDMA 1x, one of CDMA One technologies, is currently in service, and in a 3^{rd} Generation (3G) service proposed by 3G Mobile Communication Technology, the above two technologies have both been adopted.

CDMA One is compatible with 2.5G CDMA 1x, whereas UMTS is not compatible with 2.5G CDMA 1x.A UMTS service provider cannot provide a high-quality service to UMTS subscribers unless the UMTS service provider installs UMTS networks throughout the nation. To solve this problem, there has been proposed a method of providing a service to the UMTS subscribers via a CDMA 1x network in an area where a UMTS network is not installed.

Handover technology between the UMTS network and the CDMA 1x network is very important. Since the handover technology enables handover between heterogeneous networks (or heterogeneous standards), there is no appropriate interface defined for this operation. Therefore, handover between the two networks cannot be implemented unless corresponding functions are added to the standards. For example, when a UMTS subscriber moves to an area where a UMTS network is not set up while performing a voice call in a UMTS network, the call is undesirably dropped unless it is handed over to a CDMA 1x network.

In this case, a 3G UMTS subscriber cannot receive a 3G service proposed by the 3G mobile communication technology which is superior to 2G or 2.5G mobile communication technology. In addition, since UMTS research groups are in competition with CDMA research groups, there is a difficulty in defining an interface for handover between a UMTS network and a CDMA 1x network.

### SUMMARY OF THE INVENTION

It is, therefore, an object of the present invention to provide a mobile communication system capable of performing handover between mobile communication networks employing different mobile communication technologies, and a handover method using the same.

It is another object of the present invention to provide a mobile communication system capable of performing handover from a UMTS network to a CDMA 1x network to provide a nationwide service to a 3G UMTS subscriber by providing a handover to an existing CDMA 1x service in an area where a UMTS service is not provided, and a handover method using the same.

To achieve the above and other objects, there is provided a mobile communication system for performing a handover between heterogeneous mobile communication networks. The mobile communication system according to the present invention comprises a dual-mode terminal having first and second modules capable of performing communication in first and second heterogeneous communication technologies, respectively, for measuring the strength of a signal received by the first module to determine whether the dual-mode terminal has moved from one mobile communication network to another, measuring strength of a signal transmitted from a network to the second module if it is determined that the dual-mode terminal has moved to the network where communication is available with the second module, converting corresponding measurement information into a first SMS (Short Message Service) message and transmitting the first SMS message; a first mobile communication network device located in a first mobile communication network, for providing a service for performing communication with the first module, determining the measurement information from the first SMS message, and transmitting the measurement information to a network where communication is available with the second module; and a second mobile communication network device located in a second mobile communication network, for performing communication with the second module, detecting the measurement information from the data transmitted from the first mobile communication network device to assign a channel for performing communication with the second module, and transmitting the channel assignment information to the first mobile communication network device.

The first mobile communication network device converts the channel assignment information transmitted from the second mobile communication network device into a second SMS message and transmits the second SMS message to the dual-mode terminal, and the dual-mode terminal determines the channel assignment information from the second SMS message and performs communication with the second module using an assigned channel.

Preferably, the first module is an asynchronous module for performing communication with asynchronous communication technology and the second module is a synchronous module for performing communication with synchronous communication technology. Further, the first module is preferably a WCDMA (Wideband Code Division Multiple Access) module for UMTS (Universal Mobile Telecommunications System) communication, the second module is preferably a CDMA (Code Division Multiple Access) 1x module for CDMA 1x communication, the first mobile communication network is preferably a UMTS network, the second mobile communication network is preferably a CDMA 1x network, the first mobile communication network device is preferably a UMTS network device, and the second mobile communication network device is preferably a CDMA 1x network device.

The UMTS network device comprises a UTRAN (UMTS Terrestrial Radio Access Network) for setting up a wireless channel to the dual-mode terminal, communicating with the dual-mode terminal over the wireless channel, and receiving the first SMS message transmitted from the dual-mode terminal; a core network including an SMS module for determining information contained in the first SMS message, and converting other information into an SMS message; and a CDMA 1x gateway capable of interfacing with the CDMA 1x network, for transmitting restored data containing the measurement information and/or the channel assignment information to the CDMA 1x network and transmitting the channel assignment information transmitted from the CDMA 1x network to the core network.

The CDMA 1x network device comprises a plurality of base transceiver subsystems (BTSs) for setting up a wireless channel with the dual-mode terminal and performing communication with the dual-mode terminal over the wireless channel; a base station controller (BSC) for controlling the BTSs; a mobile switching center (MSC) capable of connecting a public switched telephone network (PSTN) interface with the UMTS network and the CDMA 1x network, the MSC assigning a channel to the dual-mode terminal and transmitting channel assignment information to the UMTS network; and a UMTS gateway for sending a channel assignment request to the MSC by detecting the measurement information and/or the channel assignment request signal transmitted from the UMTS network, and transmitting the channel assignment information received from the MSC to the UMTS network.

Preferably, a type of a signal measured to determine whether the dual-mode terminal has moved between different communication networks is a signal transmitted from the UMTS network device, and when it is determined that the dual-mode terminal has moved between different communication networks, a type of a signal measured to be transmitted to the UMTS network device is a signal transmitted from the CDMA 1x network device.

The first mobile communication network device receives a first SMS message, determines information contained in the first SMS message using an SMS module, detects measurement information from the information, generates channel assignment request information, and transmits the channel assignment request information to the second mobile communication network device. In response, upon receiving the channel assignment request information, the second mobile communication network device assigns a channel to the dual-mode terminal and transmits channel assignment information to the first mobile communication network device.

The measurement information and the channel assignment information are included in a user data field in an SMS message format when they are converted into an SMS message in the dual-mode terminal and the UMTS network device.

To achieve the above and other objects, there is provided a handover method comprising the steps of: a) measuring, by a dual-mode terminal, the strength of a signal transmitted from a second mobile communication network, converting the measurement information into a first SMS message and transmitting the first SMS message to a first mobile communication network device, if it is determined that the dual-mode terminal has moved from the first mobile communication network to the second mobile communication network according to measurement information of a received signal; b) receiving, by the first mobile communication network device, the first SMS message, determining the measurement information from the first SMS message, and transmitting the information to the second mobile communication network device; c) detecting, by the second mobile communication network device, the measurement information transmitted from the first mobile communication network device, assigning a channel for performing communication with a second module, and transmitting channel assignment information to the first mobile communication network device; d) converting, by the first mobile communication network device, the channel assignment information transmitted from the second mobile communication network device into a second SMS message and transmitting the second SMS message to the dual-mode terminal; and e) receiving, by the dual-mode terminal, the second SMS message, determining the channel assignment from the second SMS message, and performing communication with the second module using an assigned channel.

To achieve the above and other objects, there is provided a mobile communication system for handover between heterogeneous mobile communication networks. The mobile communication system comprises a dual-mode terminal including first and second modules capable of communicating in first and second heterogeneous communication technologies, respectively, for measuring strength of a signal received from an external communication network, and transmitting measurement information; a first mobile communication network device located in a first mobile communication network, for providing a service for performing communication with the first module, comparing the measurement information with a preset threshold to determine whether the dual-mode terminal has moved to the external communication network, and transmitting the measurement information to the external communication network if it is determined that the dual-mode terminal has moved to the external communication network; and a second mobile communication network device located in a second mobile communication network, for performing communication with the second module, detecting measurement information transmitted from the first mobile communication network device, assigning a channel for communicating with the second module, and transmitting channel assignment information to the first mobile communication network device.

The first mobile communication network device converts the channel assignment information transmitted from the second mobile communication network device into an SMS message and transmits the SMS message to the dual-mode terminal, and the dual-mode terminal receives the SMS message, determines the channel assignment information from the received SMS message, and performs communication with the second module using an assigned channel.

The mobile communication system further comprises a pilot transmitter located in the second mobile communication network device, for transmitting a dummy pilot to the first mobile communication network. The dual-mode terminal measures strength of the dummy pilot transmitted from the pilot transmitter and transmits measurement information to the first mobile communication network device.

To achieve the above and other objects, there is provided a handover method comprising the steps of: measuring, by a dual-mode terminal, the strength of a signal transmitted from a second mobile communication network device and transmitting measurement information to a first mobile communication network device; analyzing, by the first mobile communication network device, the measurement information to determine whether the dual-mode terminal has moved to a second mobile communication network; transmitting, by the fist mobile communication network device, the measurement information to the second mobile communication network device if it is determined that the dual-mode terminal has moved to the second mobile communication network; detecting, by the second mobile communication network device, the measurement information transmitted from the first mobile communication network device, assigning a channel for communicating with a second module, and transmitting channel assignment information to the first mobile communication network device; converting, by the first mobile communication network device, the channel assignment information transmitted from the second mobile communication network device into an SMS message, and transmitting the SMS message to the dual-mode terminal; and receiving, by the dual-mode terminal, the SMS message, determining the channel assignment information from the received SMS message, and performing communication with the second module using an assigned channel.

According to the present invention, it is possible to easily provide a handover service to the dual-mode terminal by exchanging handover messages between the UMTS network and the CDMA 1x network using an existing SMS function, without the need for defining a new interface for handover between the UMTS network and the CDMA 1x network.

### BRIEF DESCRIPTION OF THE DRAWINGS

The above and other objects, features and advantages of the present invention will become more apparent from the following detailed description when taken in conjunction with the accompanying drawings in which:

FIG. 1 is a block diagram of a mobile communication system for performing handover between an asynchronous mobile communication network and a synchronous mobile communication network according to an embodiment of the present invention;

FIG. 2 is a diagram of a method for determining a time to perform handover from a UMTS network to a CDMA 1x network;

FIG. 3 is a diagram of another method for determining a time to perform handover from a UMTS network to a CDMA 1x network;

FIG. 4 is a diagram of a format of an SMS message into which measurement information is converted;

FIG. 5 is a diagram of a format of an SMS message into which channel assignment information is converted;

FIG. 6 is a flowchart of a method for performing handover from a UMTS network to a CDMA 1x network according to a first embodiment of the present invention; and

FIG. 7 is a flowchart of a method for performing handover from a UMTS network to a CDMA 1x network according to a second embodiment of the present invention.

### DETAILED DESCRIPTION OF THE PREFERRED EMBODIMENT

Several preferred embodiments of the present invention will now be described in detail with reference to the annexed drawings. In the drawings, the same or similar elements are denoted by the same reference numerals even though they are depicted in different drawings. In the following description, a detailed description of known functions and configurations incorporated herein has been omitted for conciseness.

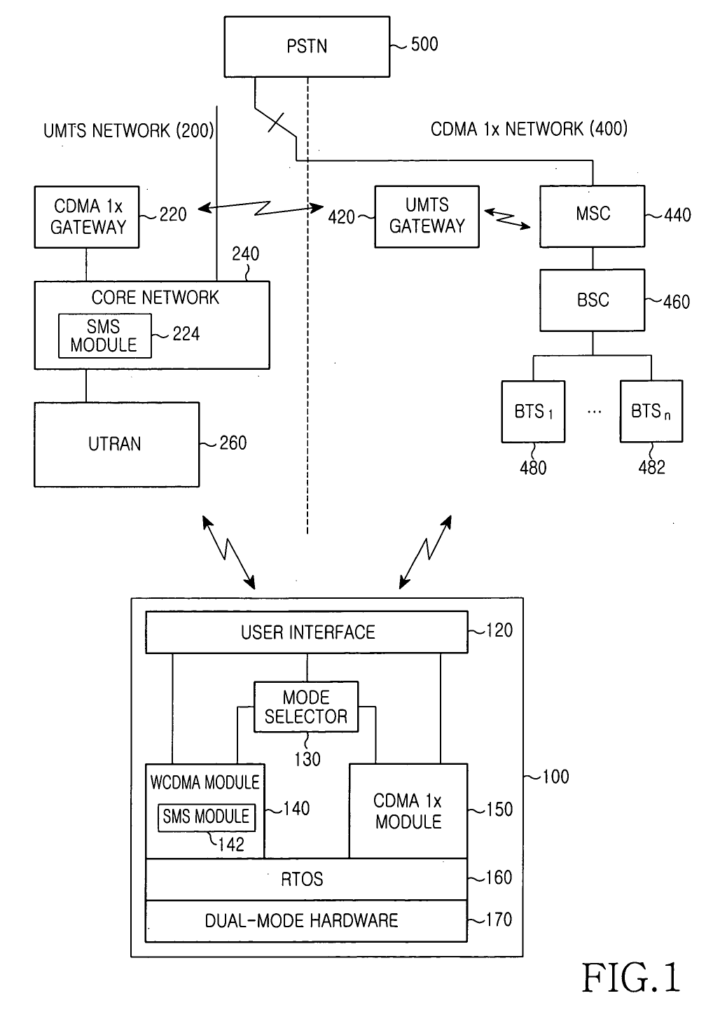

FIG. 1 is a block diagram of a mobile communication system for performing handover between an asynchronous mobile communication network and a synchronous mobile communication network according to an embodiment of the present invention. In the preferred embodiment of the present invention, the asynchronous mobile communication network employs UMTS technology, and the synchronous mobile communication network employs CDMA 1x technology. The present invention will be described regarding a mobile communication system for implementing handover between a UMTS network and a CDMA 1x network.

As illustrated in FIG. 1, the mobile communication system according to a preferred embodiment of the present invention is comprised of a dual-mode terminal 100 capable of communicating with heterogeneous mobile communication technologies, a UMTS network 200, a CDMA 1x network 400, and a public switched telephone network (PSTN) 500.

The dual-mode terminal 100 includes separate modules supporting a UMTS mobile communication technology and a CDMA 1x mobile communication technology, and performs handover between a UMTS network and a CDMA 1x network.

The dual-mode terminal 100 includes a WCDMA (Wideband CDMA) module 140, a CDMA 1x module 150, and a mode selector 130. The WCDMA module 140 performs UMTS mobile communications, and the CDMA 1x module 150 performs CDMA 1x mobile communications. The mode selector 130 selects the WCDMA module 140 or the CDMA 1x module 150 according to whether the dual-mode terminal 100 is located in the UMTS network 200 or the CDMA 1x network 400.

The WCDMA module 140 measures strength of a received signal and transmits the measurement result to the mode selector 130. The mode selector 130 compares the measurement result with a preset threshold, and if the measurement result is less than or equal to the threshold, the mode selector 130 determines that the dual-mode terminal 100 has moved from a first mobile communication network (i.e., the UMTS network 200) to a second mobile communication network (i.e., the CDMA 1x network 400).

When the dual-mode terminal 100 performs communication in a compressed mode using the WCDMA module 140 in the UMTS network 200, the CDMA 1x module 150 measures the strength of a signal that is received from the CDMA 1x network 400 for a period of time excluding a compressed mode operation time from the time for which the WCDMA module 140 is allocated, and the CDMA 1x module 150 transmits the measurement information to the mode selector 130.

To determine whether the dual-mode terminal 100 has moved to a different network, the mode selector 130 can compare the measurement information of the signal measured by the WCDMA module 140 with a preset threshold. Alternatively, the mode selector 130 can compare measurement information of signals transmitted from the UMTS network 200 and the CDMA 1x network 400, measured by the WCDMA module 140 and the CDMA 1x module 150 using the compressed mode, in order to determine whether the dual-mode terminal 100 has moved to a different network. That is, the mode selector 130 compares the measurement information of signals measured by the WCDMA module 140 and the CDMA 1x module 150 using the compressed mode, and if the measurement information of the signal measured by the CDMA 1x module 150 is greater than measurement information of the signal measured by the WCDMA module 140, the mode selector 130 determines that the dual-mode terminal 100 has moved from the UMTS network 200 to the CDMA 1x network 400.

The WCDMA module 140 of the dual-mode terminal 100 has an SMS (Short Message Service) module 142 for converting a particular message into an SMS message. If measurement information from the WCDMA module 140 is less than or equal to a preset threshold, the mode selector 130 determines that the dual-mode terminal 100 is moving from the UMTS network 200 to the CDMA 1x network 400, and thus transmits measurement information measured by the CDMA 1x module 150 in the compressed mode to the WCDMA module 140.

The WCDMA module 140 converts the measurement information from the CDMA 1x module 150 transmitted via the mode selector 130 into an SMS message using the SMS module 142, and then transmits the SMS message to the UMTS network 200. The measurement information is included in a user data field of an SMS message.

Alternatively, the mode selector 130 can transmit a CDMA 1x channel assignment request signal to the WCDMA module 140 for communication using the CDMA 1x module 150, instead of the measurement information. The WCDMA module 140 then converts the CDMA 1x channel assignment request signal transmitted from the mode selector 130 into an SMS message using the SMS module 142, and transmits the SMS message to the UMTS network 200. The CDMA 1x channel assignment request signal is included in a user data field of the SMS message.

When the dual-mode terminal 100 is located in the UMTS network 200, the UMTS network 200 provides a service to the dual-mode terminal 100 so that it can communicate using UMTS mobile communication technology. The UMTS network 200 is comprised of a CDMA 1x gateway 220, a core network (CN) 240, and a UTRAN (UMTS Terrestrial Radio Access Network) 260.

The CDMA 1x gateway 220 provides a network interface with the CDMA 1x network 400 to support handover to the CDMA 1x network 400. The core network 240 provides a service for interfacing with an external communication network established for UMTS mobile communications. In the embodiment of the present invention, the core network 240 includes an SMS module 224.

The UTRAN 260 is comprised of cells (not shown), nodes (not shown) and radio network controllers (not shown). The UTRAN 260 connects the dual-mode terminal 100 to the core network 240.

When the dual-mode terminal 100 is located in the CDMA 1x network 400, the CDMA 1x network 400 provides a service to the dual-mode terminal 100 so it can communicate using CDMA 1x communication technology. The CDMA 1x network 400 is comprised of a UMTS gateway 420, a mobile switching center (MSC) 440, a base station controller (BSC) 460, and base transceiver subsystems (BTSs) 480 to 482.

The UMTS gateway 420 interfaces with the existing CDMA 1x network 400 and the CDMA 1x gateway 220 of the UMTS network 200. The MSC 440 sets up a call path, and performs number translation. The MSC 440 provides a matching function with the PSTN 500. In addition, the MSC 440 assigns a channel to the dual-mode terminal 100 so it can communicate using the CDMA 1x module 150, and transmits channel assignment information to the UMTS gateway 420.

The BSC 460 is a base station controller located between the MSC 440 and the BTSs 480 to 482, and performs CDMA 1x call processing, wireless link control, and wired link control. The BTSs 480 to 482 are wirelessly connected to the dual-mode terminal 100. The PSTN 500 interfaces with the UMTS network 200 and the CDMA 1x network 400.

A description will now be made of a method for performing handover using the mobile communication system illustrated in FIG. 1.

Handover can occur in the following two cases. Handover can occur when the dual-mode terminal 100 moves from the UMTS network 200 to the CDMA 1x network 400, and handover can also occur when the dual-mode terminal 100 moves from the CDMA 1x network 400 to the UMTS network 200. In the following description it will be assumed that handover occurs as the dual-mode terminal 100 moves from the UMTS network 200 to the CDMA 1x network 400. However, the present invention can be also applied when handover occurs as the dual-mode terminal 100 moves from the CDMA 1x network 400 to the UMTS network 200.

A description will now be made of a method for performing handover occurring when the dual-mode terminal 100 moves from the UMTS network 200 to the CDMA 1x network 400 in an area where another UMTS network is not established.

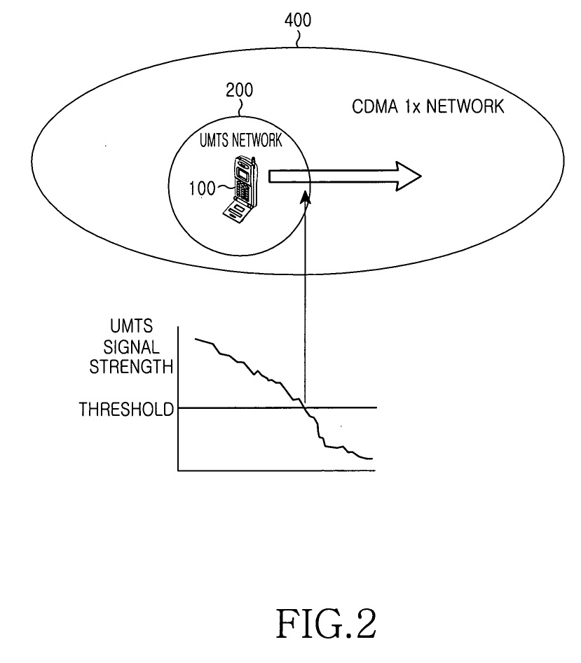

FIG. 2 is a diagram of a method for determining a time to perform handover from the UMTS network 200 to the CDMA 1x network 400. The mode selector 130 determines whether the dual-mode terminal 100 is moving from the UMTS network 200 to the CDMA 1x network 400. In determining whether the dual-mode terminal 100 is moving between networks, the mode selector 130 compares measurement information, obtained by measuring the strength of a signal received from the UMTS network 200 using the WCDMA module 140, with a preset threshold. If the measurement information is less than or equal to the threshold, the mode selector 130 determines that the dual-mode terminal 100 has moved out of the UMTS network 200. The mode selector 130 controls the CDMA 1x module 150 so that it measures the strength of a signal transmitted from the CDMA 1x network 400 in a compressed mode. Then the CDMA 1x module 150 measures the strength of a CDMA 1x signal that the CDMA 1x network 400 transmitted using the compressed mode, and transmits the measurement result, or measurement information, to the mode selector 130.

The mode selector 130 controls the WCDMA module 140 so that it converts the measurement information of the CDMA 1x signal transmitted from the CDMA 1x module 150 into an SMS message, and transmits the SMS message to the UMTS network 200.

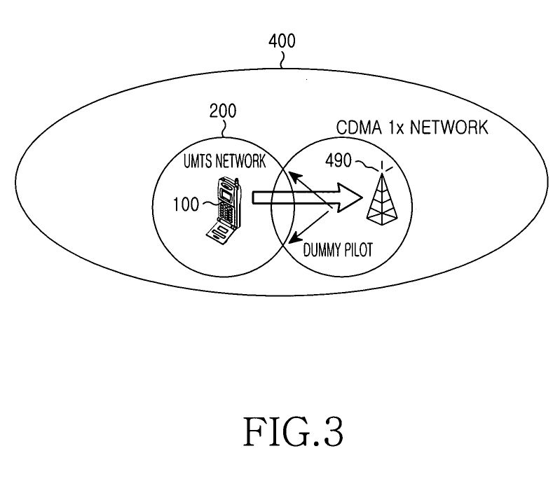

FIG. 3 is a diagram illustrating a format of an SMS message into which measurement information obtained by measuring the strength of a received CDMA 1x signal using the CDMA 1x module 150 is converted by the SMS module 142 of the WCDMA module 140. The measurement information to be transmitted to the UMTS network 200 by the WCDMA module 140 is included in a user data field of an SMS message.

As illustrated, the measurement information structure of a received CDMA 1x signal included in a user data field of an SMS message where, octet #1 represents a message type and the remaining octets can include contents designated according to particular messages. In the drawing, octet #2 represents the number of pilots, octets #3 and #4 represent pilot offset information, and octets #5 and #6 represent pilot strength information. Preferably, the WCDMA module 140 restricts a length of the measurement information of each signal so that it does not exceed the length of the SMS user data.

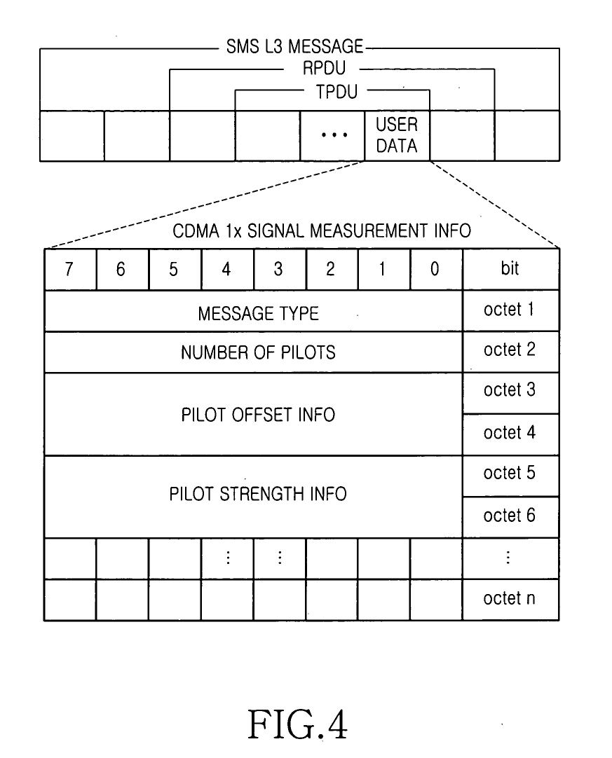

As shown in FIG. 4, TPDU (Transport Protocol Data Unit) is an actual SMS message generated by the SMS module 142 in an UMTS system, and RPDU (Relay Protocol Data Unit) is a message generated by the SMS module 142 in an UMTS system and is generated by adding additional information to the TPDU. SMS L3 (Layer 3) Message is a message made in a fundamental format to be transmitted to the UTRAN 260 of the UMTS network 200, and is generated by adding additional information to the RPDU by an SMC (Short Message Center) entity for SMS.

FIG. is a diagram for explaining another method for determining a time to perform handover from the UMTS network 200 to the CDMA Ix network 400. As illustrated, in a boundary area between the UMTS network 200 and the CDMA 1x network 400, a dummy pilot transmitter 490 is provided for transmitting a signal for providing a CDMA 1x communication service to a terminal 100 located in the CDMA 1x network 400, and also transmitting a dummy pilot for UMTS. Upon receiving a dummy pilot transmitted from the dummy pilot transmitter 490, the WCDMA module 140 measures strength of the dummy pilot and then transmits measurement information to the UMTS network 200 under the control of the mode selector 130.

The measurement information, or the measurement result, of a signal received at the WCDMA module 140 is transmitted to the UMTS network 200 in the following procedure.

The WCDMA module 140 transmits measurement information of a dummy pilot to the mode selector 130. The mode selector 130 then controls the WCDMA module 140 so that it transmits the measurement information to the UMTS network 200.

The WCDMA module 140 transmits the measurement information of the dummy pilot to the UTRAN 260 of the UMTS network 200 under the control of the mode selector 130. The UTRAN 260 transmits the measurement information to the core network 240. The core network 240 then compares the measurement information with a preset threshold, and determines whether the dual-mode terminal 100 approaches the CDMA 1x network 400 according to the comparison result.

Now, a description will be made of a procedure in which the dual-mode terminal 100 is assigned a CDMA 1x channel from the CDMA 1x network 400 after moving from the UMTS network 200 to the CDMA 1x network 400.

When an SMS message or a channel assignment request signal including the measurement information of a CDMA 1x signal is received from the dual-mode terminal 100, the core network 240 reproduces the measurement information from the SMS message using the SMS module 224, and then transmits the measurement information or channel assignment request signal to the CDMA 1x gateway 220. After comparing the dummy pilot measurement information transmitted from the dual-mode terminal 100 with a preset threshold, if it is determined that handover to the CDMA 1x network 400 should be performed, the core network 240 transmits the dummy pilot measurement information, or a channel assignment request signal, to the CDMA 1x gateway 220.

The CDMA 1x gateway 220 transmits one of the measurement information, dummy pilot measurement information, and channel assignment request signal, transmitted from the core network 240, to the CDMA 1x network 400.

The UMTS gateway 420 of the CDMA 1x network 400 receives the information transmitted from the CDMA 1x gateway 220, detects CDMA 1x signal measurement information (pilot offset and pilot strength), dummy pilot measurement information or channel assignment request signal, included in the received information, and then requests a CDMA 1x channel assignment to the MSC 440. The MSC 440 assigns a channel using one of the three kinds of information, and then transmits CDMA 1x channel assignment information to the UMTS gateway 420. The UMTS gateway 420 transmits the CDMA 1x channel assignment information to the CDMA 1x gateway 220.

A description will now be made of a procedure for transmitting CDMA 1x channel assignment information from the UMTS network 200 to the dual-mode terminal 100.

The CDMA 1x gateway 220 transmits the CDMA 1x channel assignment information transmitted from the CDMA 1x network 400, to the core network 240. The core network 240 converts the received CDMA 1x channel assignment information into an SMS message using the SMS module 244, and transmits the SMS message to the dual-mode terminal 100 via the UTRAN 260. The channel assignment message is included in a user data field of the SMS message.

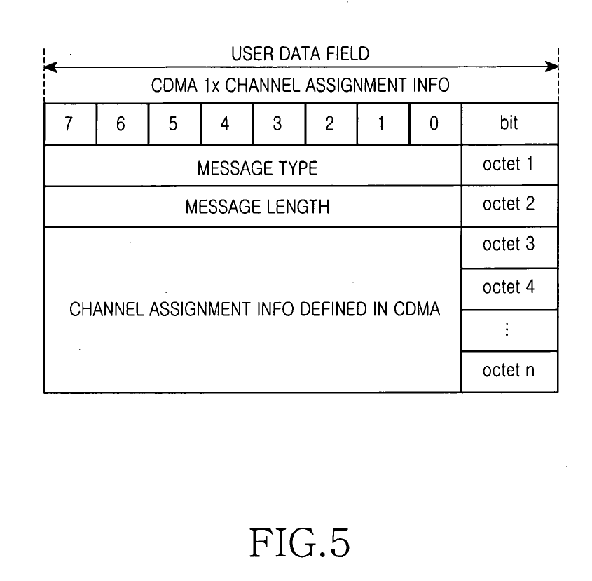

FIG. 5 is a diagram of a format of an SMS message into which the CDMA 1x channel assignment information is converted. The format of the CDMA 1x channel assignment information includes octet #1 representing a message type, octet #2 representing a message length, and octet #3 to octet #n representing a channel assignment message defined in the CDMA 1x standard.

The message type represents CDMA 1x channel assignment information, and the message length represents the size of a message in bytes. The channel assignment information defined in the CDMA 1x standard is assignment information for a CDMA 1x channel assigned to the dual-mode terminal 100.

A description will now be made of a procedure in which the dual-mode terminal 100 handovers a call to an assigned CDMA 1x channel. Upon receiving an SMS message including CDMA 1x channel assignment information, the WCDMA module 140 determines the SMS message including the CDMA 1x channel assignment information using the SMS module 142 and transmits the information to the mode selector 130.

The mode selector 130 detects channel assignment information included in the information, initializes the CDMA 1x module 150, and then controls the CDMA 1x module 150 so that it communicates using the assigned channel. The CDMA 1x module 150 then attempts communication over the assigned CDMA 1x channel.

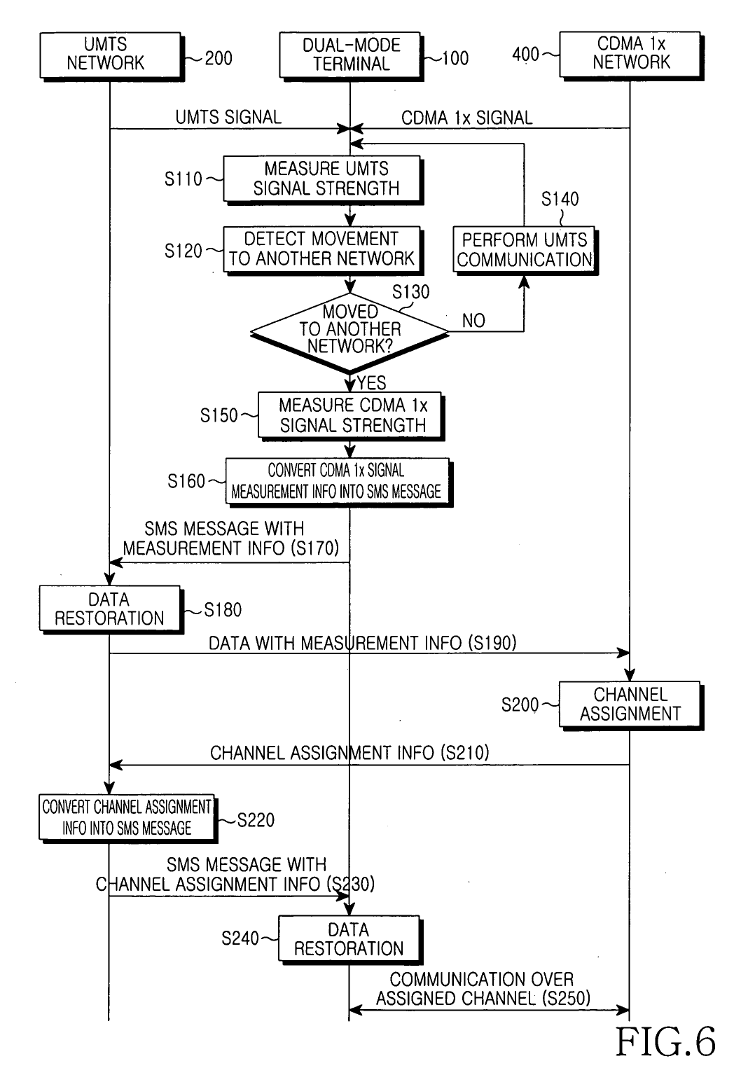

FIG. 6 is a flowchart of a method for performing handover from a UMTS network to a CDMA 1x network according to a first embodiment of the present invention based on FIGS. 1, 2, 4 and 5. In the drawing, the UMTS network 200 and the CDMA 1x network 400 transmit a UMTS signal and a CDMA 1x signal to their respective service areas.

Referring to FIG. 6, while the dual-mode terminal 100 is located in the UMTS network 200, the WCDMA module 140 receives a UMTS signal transmitted from the UMTS network 200 and measures its strength (Step S110). The mode selector 130 compares the measured UMTS signal's strength with a preset threshold to determine whether the dual-mode terminal 100 has moved to another network (Step S120).

If it is determined that the UMTS signal's strength measured by the WCDMA module 140 is greater than the threshold (Step S130), it indicates that the dual-mode terminal 100 has not moved from the UMTS network 200 to the CDMA 1x network 400, then the mode selector 130 performs UMTS communication by controlling the WCDMA module 140 (Step S140).

In contrast, if it is determined that the UMTS signal's strength measured by the WCDMA module 140 is less than or equal to the threshold (Step S130), it indicates that the dual-mode terminal 100 is moving from the UMTS network 200 to the CDMA 1x network 400. The mode selector 130 controls the CDMA 1x module 150 so that it receives a CDMA 1x signal transmitted from the CDMA 1x network 400 and measures its signal strength (Step S150). If measurement information obtained by measuring the strength of the CDMA 1x signal by the CDMA 1x module 150 is received, the mode selector 130 controls the WCDMA module 140 so that it converts the measurement information of the CDMA 1x signal into an SMS message and transmits the SMS message to the UMTS network 200 (Step S160).

The WCDMA module 140 then converts the measurement information into an SMS message by including the measurement information of the CDMA 1x signal in a user data field of an SMS message format, and transmits the measurement information-included SMS message to the UMTS network 200 (Step S170). The core network 240 of the UMTS network 200 restores the SMS message transmitted from the dual-mode terminal 100 using the SMS module 224 (Step S180).

The CDMA 1x gateway 220 transmits the measurement information to the CDMA 1x network 400 (Step S190). The UMTS gateway 420 of the CDMA 1x network 400 detects the CDMA 1x signal's measurement information from the data transmitted from the UMTS network 200 and sends a channel assignment request to the MSC 440, and the MSC 440 assigns a channel in response to the channel assignment request (Step S200) and transmits corresponding channel assignment information to the UMTS network 200 via the UMTS gateway 420 (Step S210).

The core network 240 of the UMTS network 200 converts the channel assignment information into an SMS message and includes the channel assignment information received via the CDMA 1x gateway 220 in a user data field of the SMS message format using the SMS module 224 (Step S220). The SMS message including the channel assignment information is transmitted to the dual-mode terminal 100 via the UTRAN 260 (Step S230).

The WCDMA module 140 of the dual-mode terminal 100 determines the channel assignment information from the SMS message using the SMS module 142 (Step S240). The mode selector 130, and controls the CDMA 1x module 150 so that it performs CDMA 1x communication over an assigned channel. As a result, CDMA 1x communication is performed over a channel assigned between the dual-mode terminal 100 and the CDMA 1x network 400 (Step S250).

In sum, when the dual-mode terminal 100 moves from the UMTS network 200 to the CDMA 1x network 400, strength of a signal transmitted from the CDMA 1x network 400 is measured and transmitted to the UMTS network 200 with an SMS message, and the dual-mode terminal 100 restores an SMS message including information on a channel assigned by the CDMA 1x network 400, transmitted from the UMTS network 200, and performs communication with the CDMA 1x network 400 over the assigned channel. In this way, it is possible to easily provide a handover service to the dual-mode terminal 100 using an SMS message.

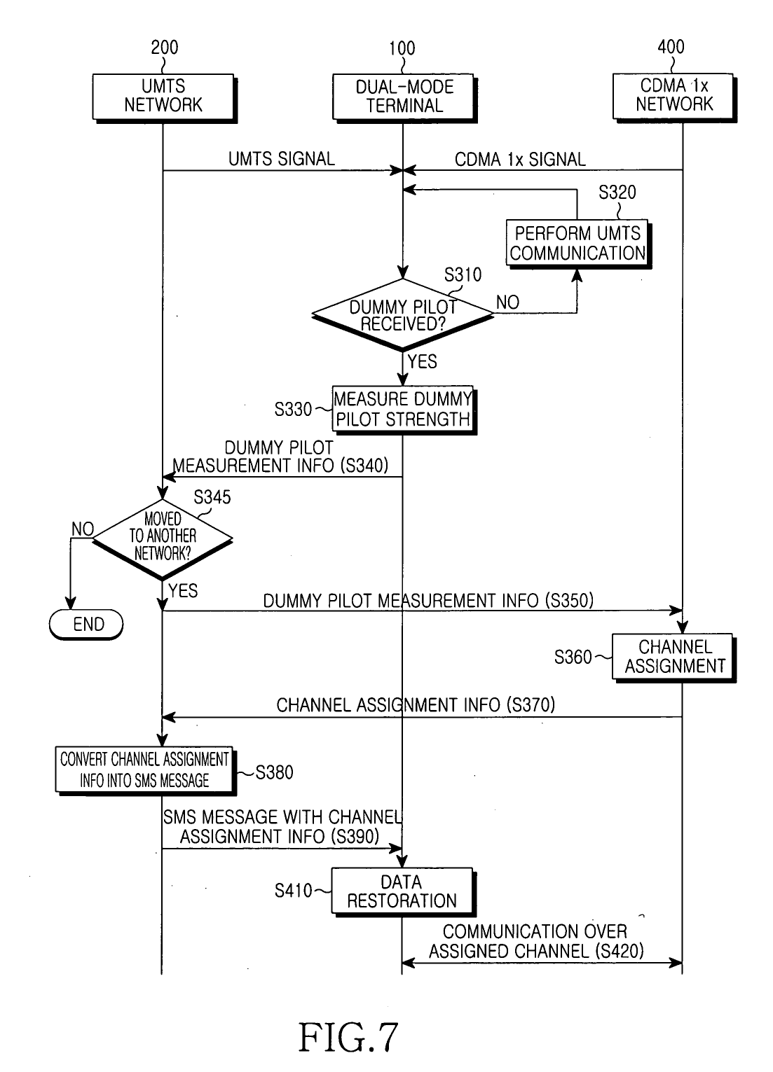

FIG. 7 is a flowchart illustrating a method for performing handover from a UMTS network to a CDMA 1x network according to a second embodiment of the present invention based on FIGS. 1, 2, 4 and 5. The UMTS network 200 and the CDMA 1x network 400 transmit a UMTS signal and a CDMA 1x signal to their respective service areas. The UMTS network 200 and the CDMA 1x network 400 transmit dummy pilots at their boundary.

Referring to FIG. 7, the mode selector 130 of the dual-mode terminal 100 determines whether a dummy pilot is received at the WCDMA module 140 (Step S310). If it is determined that no dummy pilot is received, the mode selector 130 controls the WCDMA module 140 so that it performs UMTS communications using a signal transmitted from the UMTS network 200 (Step S320).

However, if it is determined that a dummy pilot is received, the mode selector 130 controls the WCDMA module 140 so that it measures the strength of the received dummy pilot and transmits the measurement result to the UMTS network (Step S330). Then the WCDMA module 140 measures the strength of the dummy pilot and transmits the measurement information to the UMTS network 200 (Step S340).

The core network 240 compares the dummy pilot strength measurement information transmitted from the dual-mode terminal 100 with a preset threshold to determine whether the dual-mode terminal 100 has moved to another network (Step S345). If it is determined that the dual-mode terminal 100 has moved from the UMTS network 200 to the CDMA 1x network 400, the core network 240 transmits the dummy pilot measurement information or a channel assignment request signal to the CDMA 1x network 400 via the CDMA 1x gateway 220 (Step S350).

Upon detecting the dummy pilot measurement information or channel assignment request signal transmitted from the UMTS network 200, the UMTS gateway 420 sends a channel assignment request to the MSC 440, and the MSC 440 then assigns a channel in response to the channel assignment request (Step S360) and transmits corresponding channel assignment information to the UMTS network 200 via the UMTS gateway 420 (Step S370).

Upon receiving the channel assignment information transmitted from the CDMA 1x network 400 via the CDMA 1x gateway 220, the core network 240 converts the received channel assignment information into an SMS message using the SMS module 224 (Step S380). The core network 240 transmits the SMS message including the channel assignment information to the dual-mode terminal 100 via the UTRAN 260 (Step S390).

The WCDMA module 140 of the dual-mode terminal 100 restores the channel assignment information SMS message transmitted from the core network 240 using the SMS module 142 (Step S410). The mode selector 130 of the dual-mode terminal 100 detects an assigned channel from the channel assignment information and controls the CDMA 1x module 150 so that it communicates using the assigned channel. In response, the CDMA Ix module 150 communicates with the CDMA 1x network 400 using the assigned channel (Step S420).

In sum, the dual-mode terminal 100 measures the strength of a received dummy pilot, transmits the measurement information to the UMTS network 200, restores the channel assignment information SMS message assigned by the CDMA 1x network 400, transmitted from the UMTS network 200, and communicates with the CDMA 1x network 400 using the assigned channel. By doing so, it is possible to easily provide a handover service to the dual-mode terminal 100.

As can be understood from the foregoing description, when a dual-mode terminal transmits a signal received from the CDMA 1x network to the UMTS network and the UMTS network transmits channel assignment information received from the CDMA 1x network to the dual-mode terminal, the present invention uses an existing SMS function without the need of defining a new interface for handover between the UMTS network and the CDMA 1x network. By doing so, it is possible to readily provide a handover service to the dual-mode terminal.

While the invention has been shown and described with reference to a certain preferred embodiment thereof, it will be understood by those skilled in the art that various changes in form and details may be made therein without departing from the spirit and scope of the invention as defined by the appended claims.

1. A mobile communication system for performing handover between heterogeneous mobile communication networks, comprising:
a dual-mode terminal having a first module for measuring the strength of a signal received in a first network, and a second module for measuring information of a signal transmitted from a second network if it is determined that the terminal has moved from the first network to the second network, the terminal generating a first SMS (Short message Service) message including the measured signal information;
a first network device located in the first network, for communicating with the first module, receiving the first SMS message from the terminal, and transmitting the measured signal information to the second network device; and
a second network device located in the second network, for communicating with the second module, receiving the measured signal information from the first network device to assign a channel and transmitting channel assignment information to the first network device,
wherein the first network device generates a second SMS message including the channel assignment information and transmits the second SMS message to the dual-mode terminal, and the dual-mode terminal communicates with the second network using the assigned channel.

2. The mobile communication system of claim 1, wherein the first module is an asynchronous module for performing communication with asynchronous communication technology and the second module is a synchronous module for performing communication with synchronous communication technology.

3. The mobile communication system of claim 2, wherein the first module is a WCDMA (Wideband Code Division Multiple Access) module for UMTS (Universal Mobile Telecommunications System) communication, the second module is a CDMA (Code Division Multiple Access) 1x module for CDMA 1x communication, the first mobile communication network is a UMTS network, the second mobile communication network is a CDMA 1x network, the first mobile communication network device is a UMTS network device, and the second mobile communication network device is a CDMA 1x network device.

4. The mobile communication system of claim 3, wherein the WCDMA module communicates using a channel assigned by the UMTS network, measures the strength of a signal received from the UMTS network, and has an SMS module for converting corresponding information into an SMS message, wherein the CDMA 1x module communicates using a channel assigned by the CDMA 1x network and measures the strength of a signal received from the CDMA 1x network.

5. The mobile communication system of claim 4, wherein the dual-mode terminal further comprises a mode selector for controlling the WCDMA module and the CDMA 1x module, and comparing the signal strength measured by the WCDMA module with a preset threshold to determine whether the dual-mode terminal has moved from the UMTS network to the CDMA 1x network.

6. The mobile communication system of claim 5, wherein if it is determined that the dual-mode terminal has moved from the UMTS network to the CDMA 1x network, the mode selector controls the CDMA 1x module so that the CDMA 1x module measures the strength of a signal transmitted from the CDMA 1x network, and controls the UMTS module so that the UMTS module transmits measurement information measured by the CDMA 1x module to the UMTS network, wherein the WCDMA module converts the measurement information measured by the CDMA 1x module into an SMS message using the SMS module, and then transmits the SMS message to the UMTS network.

7. The mobile communication system of claim 6, wherein the WCDMA module further converts a channel assignment request signal for performing communication with the CDMA 1x module into an SMS message using the SMS module and then transmits the SMS message to the UMTS network, under the control of the mode selector.

8. The mobile communication system of claim 3, wherein the UMTS network device comprises:
a UTRAN (UMTS Terrestrial Radio Access Network) for setting up a wireless channel to the dual-mode terminal, communicating with the dual-mode terminal over the wireless channel, and receiving the first SMS message transmitted from the dual-mode terminal;
a core network including an SMS module for restoring the first SMS message that the UTRAN received, and converting information into an SMS message; and
a CDMA 1x gateway capable of interfacing with the CDMA 1x network, for transmitting restored data containing one of the measurement information and the channel assignment information to the CDMA 1x network and transmitting the channel assignment information to the core network,
wherein the core network converts the channel assignment information into an SMS message using the SMS module and transmits the SMS message to the dual-mode terminal via the UTRAN.

9. The mobile communication system of claim 8, wherein the WCDMA module restores the SMS message transmitted from the UMTS network device using the SMS module, and controls the CDMA 1x module so that the CDMA 1x module can detect the channel assignment information from the SMS message and communicate over an assigned channel.

10. The mobile communication system of claim 3, wherein the CDMA 1x network device comprises:
a plurality of base transceiver subsystems (BTSs) for setting up a wireless channel to the dual-mode terminal and communicating with the dual-mode terminal over the wireless channel;
a base station controller (BSC) for controlling the BTSs;
a mobile switching center (MSC) connectable to a public switched telephone network (PSTN) interface and the UMTS network and the CDMA 1x network, for assigning a channel to the dual-mode terminal and transmitting channel assignment information to the UMTS network; and
a UMTS gateway for sending a channel assignment request to the MSC by detecting one of the measurement information and the channel assignment request signal transmitted from the UMTS network, and transmitting the channel assignment information received from the MSC to the UMTS network.

11. The mobile communication system of claim 1, wherein upon receiving the first SMS message, the first mobile communication network device generates channel assignment request information and transmits the channel assignment request information to the second mobile communication network device, wherein upon receiving a channel assignment request signal, the second mobile communication network device assigns a channel to the dual-mode terminal and transmits channel assignment information to the first mobile communication network device.

12. The mobile communication system of claim 6, wherein the mode selector compares the strength of a signal received from the UMTS network measured by the WCDMA module to the strength of a signal received from the CDMA 1x network measured by the CDMA 1x module, and determines that the dual-mode terminal has moved from the UMTS network to the CDMA 1x network if the strength of the signal received from the CDMA 1x network is greater than the strength of the signal received from the UMTS network.

13. A handover method between mobile communication networks using a mobile communication system including a dual-mode terminal having first and second modules capable of performing communication in first and second heterogeneous communication technologies, respectively, for measuring the strength of a signal received by the first module to determine whether the dual-mode terminal has moved between the mobile communication networks, a first mobile communication network device, located in a first mobile communication network, for communicating with the first module, and a second mobile communication network device, located in a second mobile communication network, for communicating with the second module, the handover method comprising the steps of:
a) measuring, by the dual-mode terminal, the strength of a signal transmitted from the second mobile communication network, converting the measurement information into a first SMS (Short Message Service) message, and transmitting the first SMS message to the first mobile communication network device, if it is determined that the dual-mode terminal has moved from the first mobile communication network to the second mobile communication network according to the measurement information of the received signal;
b) receiving, by the first mobile communication network device, the first SMS message, restoring data from the first SMS message, and transmitting the restored data to the second mobile communication network device;
c) detecting, by the second mobile communication network device, the measurement information from the data transmitted from the first mobile communication network device, assigning a channel for performing communication with the second module, and transmitting channel assignment information to the first mobile communication network device;
d) converting, by the first mobile communication network device, the channel assignment information transmitted from the second mobile communication network device into a second SMS message and transmitting the second SMS message to the dual-mode terminal; and
e) receiving, by the dual-mode terminal, the second SMS message, restoring data from the second SMS message, detecting channel assignment information from the restored data, and performing communication with the second module using the assigned channel.

14. The handover method of claim 13, wherein the first module is a WCDMA (Wideband Code Division Multiple Access) module for UMTS (Universal Mobile Telecommunications System) communication and the second module is a CDMA (Code Division Multiple Access) 1x module for CDMA 1x communication.

15. The handover method of claim 14, wherein the first mobile communication network is a UMTS network, the second mobile communication network is a CDMA 1x network, the first mobile communication network device is a UMTS network device, and the second mobile communication network device is a CDMA 1x network device.

16. The handover method of claim 13, further comprising the steps of:
generating, by the first mobile communication network device, a channel assignment request signal and transmitting the channel assignment request signal to the second mobile communication network device, upon receiving the first SMS message transmitted in step a); and
assigning, by the second mobile communication network device, a channel to the dual-mode terminal and transmitting the channel assignment information to the first mobile communication network device, upon receiving the channel assignment request signal.

17. A mobile communication system for handover between heterogeneous mobile communication networks, comprising:
a dual-mode terminal including first and second modules capable of communicating in first and second heterogeneous communication technologies, respectively, for measuring the strength of a signal received from an external communication network, and transmitting measurement information;
a first mobile communication network device located in a first mobile communication network, for communicating with the first module, comparing the measurement information with a preset threshold to determine whether the dual-mode terminal has moved to the external communication network, and transmitting the measurement information to the external communication network if it is determined that the dual-mode terminal has moved to the external communication network; and
a second mobile communication network device located in a second mobile communication network, communicating with the second module, detecting measurement information transmitted from the first mobile communication network device, assigning a channel for performing communication with the second module, and transmitting channel assignment information to the first mobile communication network device,
wherein the first mobile communication network device converts the channel assignment information transmitted from the second mobile communication network device into an SMS (Short Message Service) message and transmits the SMS message to the dual-mode terminal, and the dual-mode terminal receives the SMS message, restores data from the received SMS message, detects the channel assignment information from the restored data, and performs communication with the second module using the assigned channel.

18. The mobile communication system of claim 17, further comprising a pilot transmitter located in the second mobile communication network device, for transmitting a dummy pilot to the first mobile communication network,
wherein the dual-mode terminal measures the strength of the dummy pilot transmitted from the pilot transmitter and transmits measurement information to the first mobile communication network device.

19. A handover method between mobile communication networks using a mobile communication system including a dual-mode terminal having first and second modules capable of performing communication in first and second heterogeneous communication technologies, respectively, for measuring the strength of a signal received from the first module, a first mobile communication network device located in a first mobile communication network, communicating with the first module, and a second mobile communication network device located in a second communication network, communicating with the second module, the handover method comprising the steps of:
measuring, by the dual-mode terminal, the strength of a signal transmitted from the second mobile communication network device and transmitting measurement information to the first mobile communication network device;
analyzing, by the first mobile communication network device, the measurement information to determine whether the dual-mode terminal has moved to the second mobile communication network;
transmitting, by the fist mobile communication network device, the measurement information to the second mobile communication network device if it is determined that the dual-mode terminal has moved to the second mobile communication network;
detecting, by the second mobile communication network device, measurement information transmitted from the first mobile communication network device, assigning a channel for performing communication with the second module, and transmitting channel assignment information to the first mobile communication network device;
converting, by the first mobile communication network device, the channel assignment information transmitted from the second mobile communication network device into an SMS (Short Message Service) message, and transmitting the SMS message to the dual-mode terminal; and
receiving, by the dual-mode terminal, the SMS message, restoring data from the received SMS message, detecting channel assignment information from the restored data, and performing communication with the second module using the assigned channel.

20. The handover method of claim 19, wherein a dummy pilot transmitted from a pilot transmitter located in the second mobile communication network to the first mobile communication network is the signal transmitted from the second mobile communication network device.

21. A dual-mode terminal capable of performing communication with heterogeneous communication technologies, comprising:
a first module for performing communication using a channel assigned by a first mobile communication network, measuring the strength of a signal received from the first mobile communication network, and converting corresponding measurement information into an SMS (Short Message Service) message;
a second module for performing communication using a channel assigned by the second mobile communication network, and measuring the strength of a signal received from the second mobile communication network; and
a mode selector for controlling the first and second modules according to an assigned channel, comparing the signal strength measured by the first module with a preset threshold to determine whether the dual-mode terminal has moved from the first mobile communication network to the second mobile communication network, and if it is determined that the dual-mode terminal has moved to the second mobile communication network, and controlling the first module so that the first module converts measurement information of the signal strength measured by the second module into a first SMS message and transmits the first SMS message to the first mobile communication network,
wherein if a second SMS message including channel assignment information from the second mobile communication network is received in response to the first SMS message, the mode selector controls the second module so that the second module performs communication using an assigned channel.

22. The dual-mode terminal of claim 21, wherein the first module is an asynchronous module for performing communication with asynchronous communication technology and the second module is a synchronous module for performing communication with synchronous communication technology.

23. The dual-mode terminal of claim 22, wherein the first module is a WCDMA (Wideband Code Division Multiple Access) module and the second module is a CDMA (Code Division Multiple Access) 1x module.
